(19) United States
(12) Patent Application Publication
(10) Pub. No.: US 2003/0025694 A1
(43) Pub. Date: Feb. 6, 2003

(54) Method of rendering bitmap images into three dimensions

(75) Inventor: Steve Davis, Owasso, OK (US)

Correspondence Address: HOVEY WILLIAMS LLP, Suite 400, 2405 Grand Boulevard, Kansas City, MO, 64108, US

(73) Assignee: PUNCH! SOFTWARE, LLC

(21) Appl. No.: 10/165,847

(22) Filed: Jun. 6, 2002

Related U.S. Application Data
(60) Provisional application No. 60/296,155, filed on Jun. 6, 2001.

(51) Int. Cl. G06T 15/00

(52) U.S. Cl. 345/419

(57) ABSTRACT

A method and computer program for viewing a two-dimensional digital image (82) within a three-dimensional environment (46) is disclosed. The inventive method and program enable a user to view relatively simple self-generated two-dimensional images such as photographs or the like in a computer-generated three-dimensional environment and manipulated as if it's a three-dimensional image thereby having the advantages of a three-dimensional digital image while eliminating the relatively complex, costly and time-consuming task of creating the three-dimensional digital image. A preferred method is disclosed broadly including step (36) of defining a three-dimensional environment, step (38) of preparing the two-dimensional image for placement in the three-dimensional environment, step (40) of placing the two-dimensional image in the three-dimensional environment, step (42) of editing the two-dimensional image and the three-dimensional environment, and step (44) of virtually viewing the three-dimensional environment and images therein from various perspectives.

### RELATED APPLICATIONS

This application claims the benefit of U.S. Provisional Application Ser. No. 60/296,155 filed Jun. 6, 2001 and entitled METHOD OF RENDERING BITMAP IMAGES INTO THREE DIMENSIONS that is hereby incorporated herein by reference.

### USER'S GUIDE APPENDIX

A user's guide of a computer program that may be used with the present invention is incorporated herein by reference and appended hereto as an original First edition, 2001 of Master Landscape & Home Design User's Guide.

### BACKGROUND OF THE INVENTION

1. Field of the Invention

The present invention relates generally to methods of viewing a two-dimensional digital image within a three-dimensional environment. More specifically, the present invention concerns a method and computer program for viewing a two-dimensional digital image within a three-dimensional environment that enables a user to view relatively simple self-generated two-dimensional images such as photographs or the like in a computer-generated three-dimensional environment. The two-dimensional image can be viewed and manipulated as if it's a three-dimensional image thereby having the advantages of a three-dimensional digital image while eliminating the relatively complex, costly and time-consuming task of creating the three-dimensional digital image.

2. Discussion of Prior Art

Prior to building on or modifying real estate (e.g., remodeling a house, altering the landscape, etc.), it is desirable to create a scaled plan design in advance to visualize the desired change. It is known in the art to create designs using a computer system that enables realistic looking three-dimensional digital simulations of the planned changes in combination with the existing structure. These prior art design methods include drawing the existing structure in three-dimensional views using computer-aided drafting software such as available under the designation AutoCAD from Autodesk, inc. of San Rafael, Calif. and either drafting the modifications in a three-dimensional view with the existing structure or adding the modifications selected from a database of preselected three-dimensional views of various modifications. It is also known in the art to photograph the existing structure to create a two-dimensional digital image thereof (e.g., using a digital camera, using a non-digital camera and scanning the photograph into the computer system, etc.) that can be modified in a two-dimensional environment.

These prior art design methods are problematic and suffer from several limitations. For example, it is undesirably complex, costly and time-consuming to create the three-dimensional views of the existing structure. This is particularly prohibitive when the application involves simulating relatively simple changes in the landscape surrounding the existing structure. Furthermore, the two-dimensional environment is undesirable as it less realistic than a three-dimensional environment.

### SUMMARY OF THE INVENTION

The present invention provides an improved method and computer program for viewing a two-dimensional digital image within a three-dimensional environment that enables a user to view relatively simple self-generated two-dimensional images such as photographs or the like in a computer-generated three-dimensional environment. The two-dimensional image can be viewed and manipulated as if it's a three-dimensional image thereby having the advantages of a three-dimensional digital image while eliminating the relatively complex, costly and time-consuming task of creating the three-dimensional digital image.

A first aspect of the present invention concerns a method of viewing a two-dimensional digital image within a three-dimensional environment. The inventive method broadly includes the steps of displaying the three-dimensional environment on a computer display, preparing the two-dimensional digital image for placement into the three-dimensional environment, placing the two-dimensional digital image into the three-dimensional environment for display on the computer display, selectively placing additional digital images into the three-dimensional environment for display with the two-dimensional digital image on the computer display, providing a virtual viewpoint within the three-dimensional environment so that a user viewing the display visualizes the three-dimensional environment as if the user is positioned therein at the virtual viewpoint, and permitting the user to selectively change the viewpoint to enable the user to visualize the images in the three-dimensional environment from various viewpoints.

A second aspect of the present invention concerns a computer program for viewing a two-dimensional digital image within a three-dimensional environment. The computer program is stored on a computer-readable medium and executable by a computing device. The computer program broadly includes a first code segment for displaying the three-dimensional environment on a computer display, a second code segment for preparing the two-dimensional digital image for placement into the three-dimensional environment, a third code segment for placing the two-dimensional digital image into the three-dimensional environment for display on the computer display, a fourth code segment for selectively placing additional digital images into the three-dimensional environment for display with the two-dimensional digital image on the computer display, a fifth code segment for providing a virtual viewpoint within the three-dimensional environment so that a user viewing the display visualizes the three-dimensional environment as if the user is positioned therein at the virtual viewpoint, and a sixth code segment for permitting the user to selectively change the viewpoint to enable the user to visualize the images in the three-dimensional environment from various viewpoints.

A third aspect of the present invention concerns data created by a computer program for viewing a two-dimensional digital image within a three-dimensional environment. The computer program is stored on a computer-readable medium and executable by a computing device. The computer program for creating the data broadly includes a code segment for displaying the three-dimensional environment on a computer display, a code segment for preparing the two-dimensional digital image for placement into the three-dimensional environment, a code segment for placing the two-dimensional digital image into the three-dimensional environment for display on the computer display, a code segment for selectively placing additional digital images into the three-dimensional environment for display with the two-dimensional digital image on the computer display, a code segment for providing a virtual viewpoint within the three-dimensional environment so that a user viewing the display visualizes the three-dimensional environment as if the user is positioned therein at the virtual viewpoint, and a code segment for permitting the user to selectively change the viewpoint to enable the user to visualize the images in the three-dimensional environment from various viewpoints.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 is an elevational view of a system constructed in accordance with a preferred embodiment of the present invention;

FIG. 2 is a block diagram showing interrelationships of a plurality of subprograms of a computer program according to a preferred embodiment of the present invention;

FIG. 3 is a flowchart showing steps in a method according to a preferred embodiment of the present invention;

FIG. 4 is an exemplary screen capture generated by the computer program of FIG. 2 illustrating the three-dimensional environment;

FIG. 5 is an exemplary screen capture generated by the computer program illustrating the two-dimensional digital image in the three-dimensional environment;

FIG. 6 is an exemplary screen capture generated by the computer program illustrating additional images with the two-dimensional digital image in the three-dimensional environment;

FIG. 7 is an exemplary screen capture generated by the computer program illustrating the three-dimensional environment of FIG. 6 from a varying viewpoint; and

FIG. 8 is an exemplary screen capture generated by the computer program illustrating a side view of the two-dimensional digital image in the three-dimensional environment.

### DETAILED DESCRIPTION OF THE PREFERRED EMBODIMENTS

The present invention is a method and computer program for viewing a two-dimensional digital image within a three-dimensional environment that enables a user to view relatively simple self-generated two-dimensional images such as photographs or the like in a computer-generated three-dimensional environment. In a preferred embodiment described herein, the method of viewing the two-dimensional digital image within the three-dimensional environment is implemented using the computer program comprising a number of subprograms and databases. The subprograms and databases are advantageously operable to enable the two-dimensional image to be viewed and manipulated as if it's a three-dimensional image thereby having the advantages of a three-dimensional digital image while eliminating the relatively complex, costly and time-consuming task of creating the three-dimensional digital image.

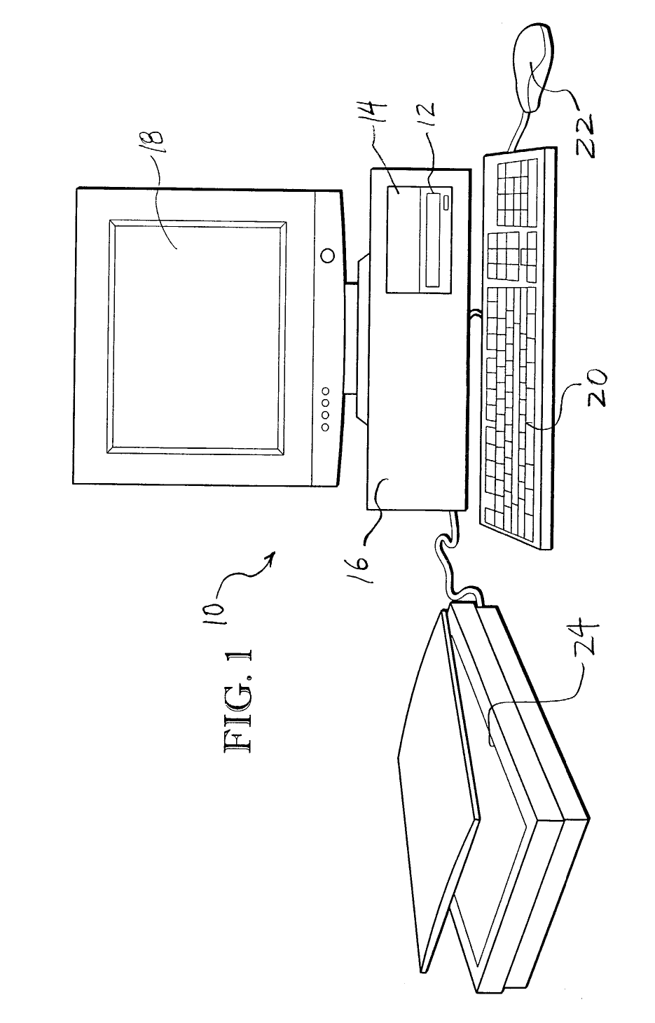

Referring to FIG. 1, a system 10 is shown operable to store, access and execute the computer program of the present invention. The illustrated system 10 is a desktop computer, such as for example a personal computer (PC), commonly available from a variety of well-known suppliers. However, the system 10 may be any suitable conventional computing device having sufficient resources and ability to perform the functions described herein. Regardless of its form, however, the preferred system 10 broadly includes a first memory 12, a second memory 14, a processor 16, a display 18, a first input device 20, a second input device 22, and a third input device 24.

The first memory 12 is operable to store one or more of the subprograms and databases of the computer program. The illustrated first memory 12 comprises a compact disk and a drive for reading the compact disk (e.g., a CD-ROM drive). However, the first memory 12 could alternatively utilize any similar conventional computer memory such as a hard drive, a floppy disk drive, etc. The second memory 14 is operable to store one or more portions of one or more of the subprograms and databases during execution thereof. The illustrated second memory 14 is a random access memory (RAM), however, any other similar conventional computer memory may be utilized.

The processor 16 is operable to execute the computer program. The display 18 is operable to communicate information generated by the processor 16 during execution of the computer program. The first, second, and third input devices 20, 22, and 24 are operable to allow a user to interact with the computer program. It will be appreciated that the nature of the processor 16, the display 18, and the input devices 20,22,24 utilized can vary depending on the nature of the system 10, although all are preferably commonly available from a variety of well-known suppliers. For example, in the illustrated PC system 10, the processor 16 is relatively more powerful, the display 18 is relatively larger, and the input devices 20, 22, and 24 are a keyboard, a mouse, and a scanner, respectively, compared to corresponding similar components that could be utilized in a more portable type system 10 such as a conventional laptop or a PDA.

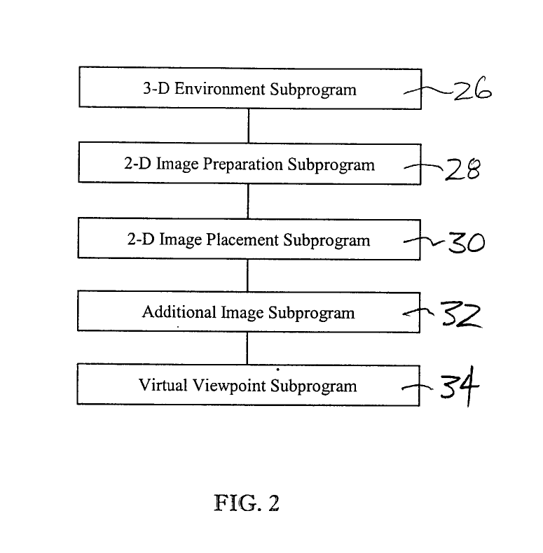

A preferred mechanism for performing the method of the present invention is the computer program illustrated in FIG. 2. The computer program comprises a number of subprograms and databases, preferably broadly including a 3-D Environment Subprogram 26, a 2-D Image Preparation Subprogram 28, a 2-D Image Placement Subprogram 30, an Additional Image Subprogram 32, and a Virtual Viewpoint Subprogram 34. The computer program is operable to be stored on the first and/or second memories 12,14 and executed by the processor 16. Though implementable in any conventional computer programming language for any operating system, the illustrated program is preferably implemented in C for Microsoft Windows. It will be appreciated that it is within the ambit of the present invention to utilize various alternative mechanisms for implementing the present invention, particularly with regard to changes in presentation and/or appearance.

In a preferred embodiment, the computer program is a module for use in connection with a fully-integrated, multi-tiered design program. One such design program is commercially available from Punch! Software, LLC of Kansas City, Mo. under the trade name Master Landscape & Home Design as version 4.1.0. A User's Guide for the Master Landscape & Home Design software is submitted herewith and incorporated herein by reference. However, it is within the ambit of the present invention to utilize the inventive computer program in connection with any suitable application software or as a stand-alone, independent program.

The 3-D Environment Subprogram 26 is operable to create a three-dimensional environment for display on the display 18. The Subprogram 26 preferably enables the user to select from a variety of databases to create the desired three-dimensional environment. For example, the preferred Subprogram 26 enables the user to define a fixed horizon in the three-dimensional environment and thus databases may include ground cover databases, topography databases, sky, and lighting databases to define the desired environment. In the preferred embodiment, the Subprogram 26 accesses databases provided by the application design software.

The 2-D Image Preparation Subprogram 28 is operable to prepare the two-dimensional digital image for placement into the three-dimensional environment. The Subprogram 28 preferably enables the user to import the two-dimensional image into the program and converting it, if necessary, into digital format. For example, if the image is a photograph taken with a non-digital camera, the Subprogram 28 enables the photograph to be input with the scanner 24 into the program in a digital format (e.g., bitmap, jpeg, etc.). Additionally, the Subprogram 28 enables the user to define the dimensions of the image relative to the three-dimensional environment. Furthermore, as will subsequently be described in detail, in the preferred method of the present invention, the Subprogram 28 enables the user to crop and mask the image, for example so that only a desired object (e.g., a home, a building, etc.) is displayed from the image. It is within the ambit of the present invention to utilize commercially available image editing software to crop and mask the image, (e.g., PhotoShop, Microsoft Paint, etc.).

The 2-D Image Placement Subprogram 30 is operable to place the two-dimensional digital image into the three-dimensional environment for display on the display 18. The Subprogram 30 preferably projects the image onto a transparent plane so that only the unmasked portions of the image can be viewed on the display 18. As will be described in detail below, in the preferred method, the Subprogram 30 additionally provides shading and shadowing to the unmasked portions of the image to correspond with lighting conditions defined in the three-dimensional environment. Furthermore, the Subprogram 30 preferably enables the user to view the two-dimensional image in a variety of layouts, including for example elevation and plan views.

The Additional Image Subprogram 32 is operable to place additional digital images into the three-dimensional environment for display with the two-dimensional digital image on the display 18. The Subprogram 32 preferably enables the user to select both two-dimensional and three-dimensional images from a variety of databases for placement into the three-dimensional environment. Additionally, as will be described in detail below, the Subprogram 32 preferably enables the user to generate three-dimensional images by combining standard components. For example, preferred databases include two-dimensional landscape images such as bushes, trees, shrubs, etc. as well as home addition databases such as decks, doors, fencing, pavement, windows, etc. In the preferred embodiment, the Subprogram 32 accesses databases provided by the application design software.

The Virtual Viewpoint Subprogram 34 is operable to provide a virtual viewpoint within the three-dimensional environment so that the user viewing the display 18 visualizes the environment as if the user is positioned therein at the viewpoint and permits the user to selectively change the viewpoint. As will be described in detail below, the Subprogram 34 preferably enables the user to “walk through” the environment. Therefore, the preferred Subprogram 34 displays the additional images placed by the Subprogram 32 in perspective so that the perspective dimensions change as the viewpoint varies. As will be described, the two-dimensional images placed by the Subprogram 32 are preferably planar images and the Subprogram 34 maintains the planar images perpendicular to the viewpoint as the viewpoint changes to “affect” a three-dimension appearance.

It is within the ambit of the present invention to utilize any suitable mechanism to practice the method of the present invention, including various alternative subprograms and databases corresponding to relevant aspects of selected applications of the present invention.

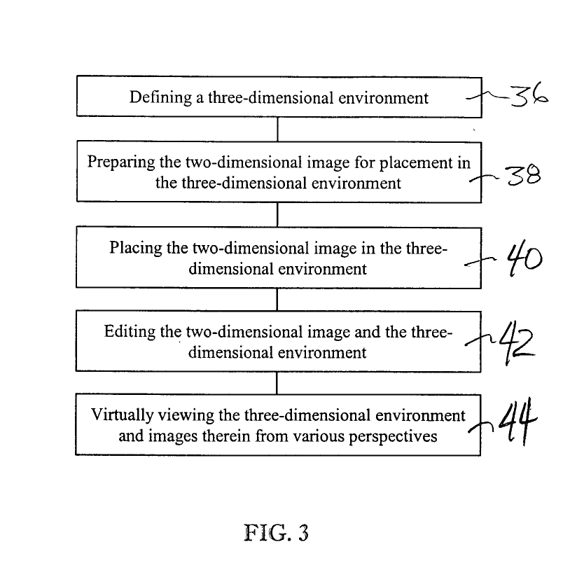

In use and operation and as illustrated in FIG. 3, a preferred method of the present invention broadly includes step 36 of defining a three-dimensional environment, step 38 of preparing the two-dimensional image for placement in the three-dimensional environment, step 40 of placing the two-dimensional image in the three-dimensional environment, step 42 of editing the two-dimensional image and the three-dimensional environment, and step 44 of virtually viewing the three-dimensional environment and images therein from various perspectives.

In more detail, step 36 of defining a three-dimensional environment enables the user to create the desired environment in which the two-dimensional image will be viewed. For example, if the two-dimensional image to be viewed is a photograph of the user's home, the three-dimensional environment is desirably the user's property surrounding the home, including the surrounding ground and the surrounding skyline, divided by the fixed horizon at the time the photograph was taken. The ground will include the appropriate grass, trees, water, pavement, etc. and the skyline will include the appropriate lighting and conditions, such as sunny, cloudy, starry, etc..

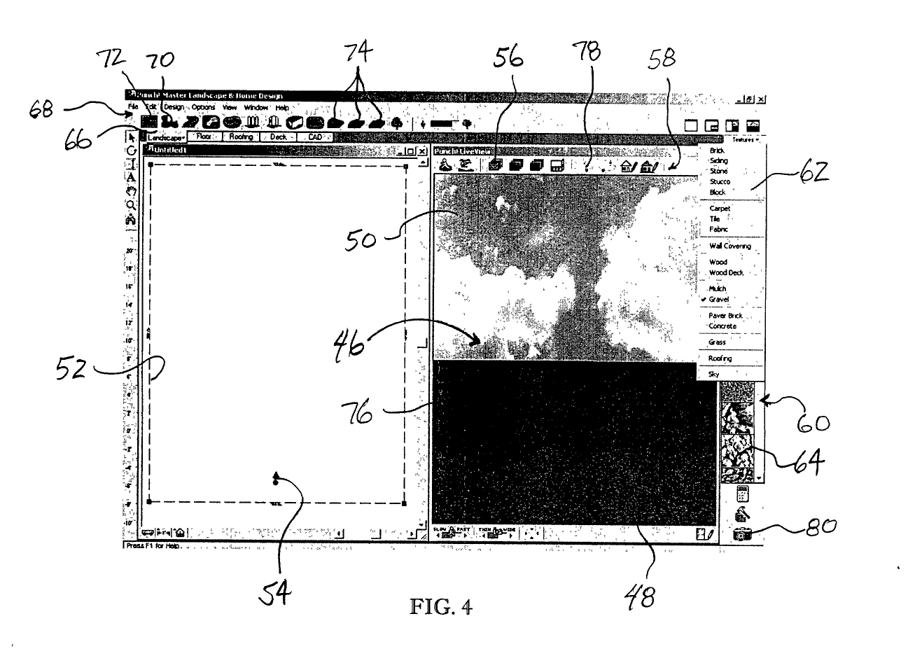

As previously indicated, in the preferred embodiment, step 36 is facilitated by the Subprogram 26 in cooperation with the Master Landscape & Home Design software. Referring now to the screen capture depicted in FIG. 4, an exemplary three-dimensional environment 46 is illustrated. The environment 46 includes a grass covered ground 48 and a cloudy sky 50 divided by the horizon. The screen capture illustrated in FIG. 4 is a split screen including a plan view of the environment 46 opposite the three-dimensional environment 46. The plan view depicts a scaled property line 52 showing dimensions of one hundred feet by seventy-five feet. A viewpoint carat 54 marks the current virtual viewpoint as will be described in detail below.

The illustrated three-dimensional environment 46 is the default environment, however, the user can variously configure the environment 46 by using the mouse 22 to select one or more of the applicable icons located on one of the toolbars. Each of the icons correspond to a relevant database. For example, the user can modify the grass covered ground by selecting, i.e. clicking on, the texture icon 56 located on the live view toolbar 58 causing various other texture-related icons to appear on the preview bar 60. The user can then click on the heading “texture” located at the top of the preview bar 60 and the pop-out menu 62 appears displaying several texture-related database buttons. The user can then select a button corresponding to the desired database. For example, the GRAVEL button calls up various gravel textures 64 into the preview bar 60. The user can then select the desired texture and drag it into the desired area to fill. If the desired fill area is less than the entire ground area, this area can first be defined on the plan view by selecting the LANDSCAPE tab 66 causing the landscape toolbar 68 to be displayed. From the toolbar 68, the user selects the ground fill icon 70. The user then simply moves the mouse 22 to the desired starting point of the desired area on the plan view and draws the area with the mouse 22, i.e., creating a “rubberband” line, clicking the mouse 22 at each corner point and arriving back at the starting point where the user double-clicks the mouse 22. Dimensions of the fill area appear between each cornerpoint. In a similar manner, the user can draw or modify the property line 52 by selecting the property line icon 72. Although the illustrated ground 48 is flat, in a manner similar to those just described, the topography can be modified by selecting one of the slope icons 74 from the landscape toolbar 68, selecting a corresponding slope database from the preview bar 60, drawing the relevant slope points on the plan view, and dragging and dropping the selected slope therein.

The lighting of the environment 46 can also be modified. In the illustrated environment 46, a medium intensity and medium brightness virtual sun, although not pictured in the sky 50, is positioned in the sky above and to the right of the property line 52 relevant to the plan view. Accordingly, shading 76 appears in the lefthand portion of the ground 48 from the illustrated viewpoint indicated by the carat 54. The user can modify this lighting by selecting the light icon 78 on the toolbar 58. A pop-out lighting menu (not shown) appears and the user can select from one of several “sun” locations and can adjust the intensity and brightness of the light with corresponding lateral scroll bars (not shown).

Step 38 of preparing the two-dimensional image for placement in the three-dimensional environment enables the user to select an image of virtually any object for importation into and subsequent virtual viewing in the three-dimensional environment 46. The user must first create and/or select a two-dimensional image to be viewed in the environment 46 and then import it into the system 10 in digital format. This will typically involve selecting an actual object the user desires to view in the environment 46 and taking a photograph of the object. For example, if the user desires to view an image of the user's home in the environment 46, the user simply photographs the home using any form of photography known in the art. For purposes that will subsequently be described, the subsequent viewing of the image will be optimized if the photograph is an elevational view of one of the sides of the object (e.g., the front of the home taken from a viewpoint perpendicular to the home, etc.). If the photograph is created with a digital camera (e.g., stored in digital format on a CD), the photograph can be downloaded into the system 10 via the first memory 12. If the photograph is created with a non-digital camera (e.g., a chemical film camera, etc.), the photograph can be input into the system 10 using the scanner 24. In one manner known in the art, the scanner 24 imports the scanned photograph into the second memory 14 in bitmap format.

Once the two-dimensional image is downloaded into the system 10, the image is preferably cropped and/or masked so that only the representation of the actual object desired to be viewed remains unmasked and uncropped. As will be described in detail below, in this manner the three-dimensional “affect” is optimized as realistic shadowing can be accomplished. For example, if the user's home is the desired object to be viewed and the downloaded image includes the home and a portion of the surrounding background, the image is preferably cropped so that the edges of the home generally match the margins of the image. Any background remaining should be masked to “true” black (using any manner known in the art). As will be subsequently described, portions of the image that are masked to “true” black appear transparent in the environment 46.

As previously indicated, the 2-D Image Preparation Subprogram 28 is most preferably operable to facilitate the processes of step 38 described above in preparing the two-dimensional image for placement into the three-dimensional environment. However, in the version of Master Landscape & Home Design described in the previously incorporated User's Guide appended hereto, the above described processes of step 38 utilize commercially available third-party software, as is within the ambit of the present invention. Once the two-dimensional digital image is prepared for placement into the environment 46, the Subprogram 28 stores it in an image database accessible by the photo launch button 80 (see FIG. 4). When the user selects the photo launch button 80, the database with the digital image file appears and the user can simply double-click the desired file. A pop-out photo property menu appears (not shown) that enables the user to input the actual dimensions (height and width) of the object into this menu using the keyboard 20. Once the dimensions have been entered, the two-dimensional digital image is ready for placement into the environment 46.

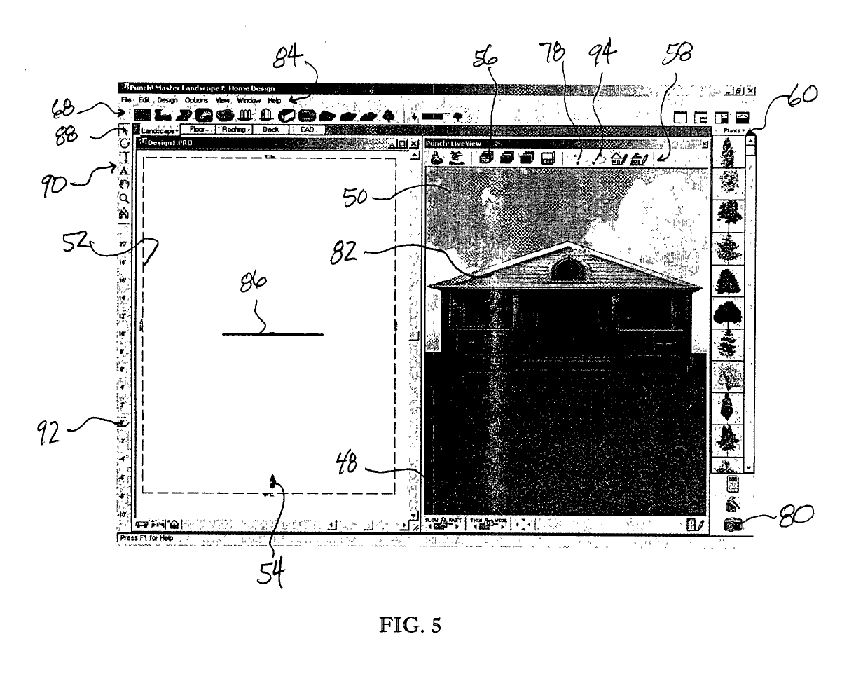

Once the two-dimensional digital image is ready for placement into the environment 46, step 40 of placing the two-dimensional image in the three-dimensional environment enables the user to import the image into the environment 46 for viewing on the display 18. Particularly, step 40 is preferably facilitated by the 2-D Image Placement Subprogram 30. As illustrated in FIG. 5, a two-dimensional digital image 82 of the facade of house is shown placed in the three-dimensional environment 46. As described above, once the user selects the photo launch button 80, selects the desired file from the database, and inputs the dimensions, the image 82 is ready for placement in the environment 46. The user simply selects the OK button on the pop-out photo property menu and the Subprogram 30 imports the image 82 into the environment 46. The image 82 can also be inserted by selecting the FILE button on the menu bar 84, causing a pop-out file menu (not shown) to appear, and selecting the INSERT PHOTOVIEW IMAGE button to call up the digital image database (then following the same processes previously described). In the illustrated program, the image 82 is also represented in the plan view as a line 86 scaled relative to the property line 52.

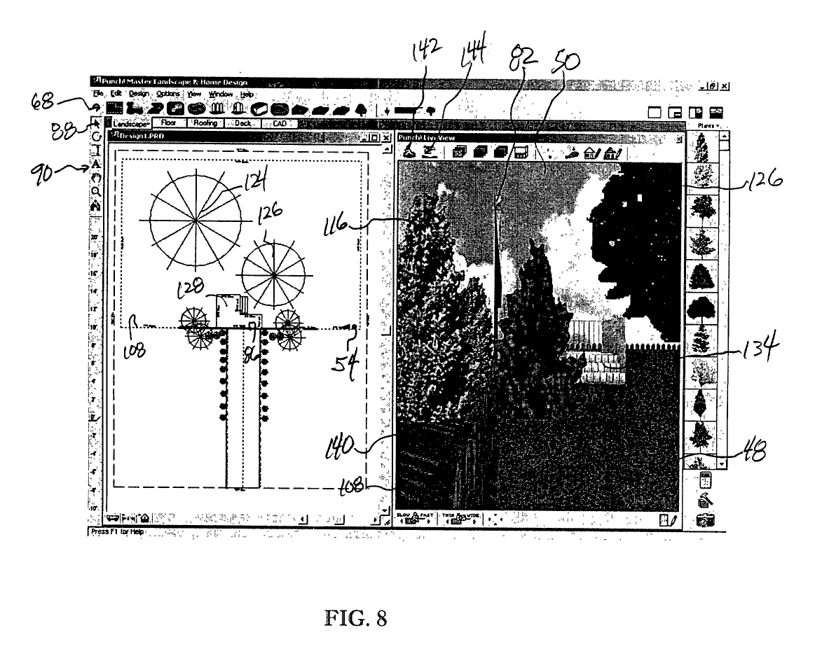

In the illustrated embodiment, the Subprogram 30 applies the image 82 to a geometric transparent plane within the environment 46 (see, e.g., FIG. 8). Portions of the image 82 that have been masked are also transparent. Where the image 82 has been optimally cropped and masked, the image 82 has the appearance or “affect” of a three-dimensional object in the environment 46. This three-dimensional “affect” is enhanced by such features as shading, shadowing, and enabling various viewpoints of the image 82.

In more detail, in the illustrated program, as default settings, the Subprogram 30 places the image 82 in the center of the lot defined by the property line at an elevation corresponding to the image 82 resting on the ground 48. Additionally, the Subprogram 30 adds shading to the image 82 that generally matches the shading from the environment 46. For example, the illustrated image 82 has a relatively darker shaded portion toward the bottom of the image 82 and a relatively lighter portion toward the top of the image 82 corresponding to the shading 76 and the previously selected location of the virtual sun. Once the image 82 has been placed in the environment 46, the user can modify the image's location, elevation, shading, etc. For example, to move the image 82, the user selects the selection tool icon 88 from the standard toolbar 90 with the mouse 22. The user then clicks generally on the center of the line 86 in the plan view and drags the line 86 to the new desired location and releases it. It is important that the user select the line 86 generally at its center because if the user selects the line 86 on an endpoint and drags the mouse 22, the width of the image 82 will be altered. Alternatively, the user could select the selection tool icon 88 and then select the line 86 in the plan view and right click the line 86 with the mouse 22. This causes a pop-out menu (not shown) to appear. The user selects the MOVE button (not shown) from the pop-out menu causing a Move dialog box (not shown) to appear. The user can then enter either Cartesian or polar X- and Y-Axis coordinates using the keyboard 20. When the user clicks the OK button (not shown) on the dialog box, the line 86 is moved to the coordinate location that was entered.

The user can alter the elevation of the image 82 by using the selection tool icon 88 to select the line 86 as previously described, then selecting the EDIT button on the menu bar 84, then selecting the SET OBJECT ELEVATION button from the pop-out menu (not shown) that appears. A Set Elevation dialog box (not shown) will appear in which the user can enter a distance (in inches) using the keyboard 20. When the user selects the OK button on the Set Elevation dialog box, the image 82 will be elevated by the distance entered. Alternatively, the user can use the selection tool icon 88 to select the line 86 and then drag the Elevation Slider 92 on the standard tool bar 90 to the desired elevation position. When the user releases the Slider 92, the image 82 will be elevated to the selected position. As previously indicated, the dimensions of the image 82 can be modified by using the selection tool icon 88 and either clicking and dragging and endpoint of the line 86 or by double-clicking the image 82 to call up the pop-out photo property menu and entering new dimensions with the keyboard 20. The image 82 can also be flipped using the pop-out photo property menu. To rotate the image 82, the user selects the EDIT button from the menu bar 84 and then selects the ROTATE button from the pop-out menu that appears to call up a Rotate dialog box (not shown). The degree of desired rotation can then be entered using the keyboard 20, and the image 82 will be rotated the entered degree when the user selects the OK button on the Rotate dialog box.

The shading of the image 82 can be modified using the light icon 78 in the manner previously described with respect to the shading 76. Additionally, as will be described in further detail below, the user can add shadows to the image 82 to enhance the three-dimensional “affect.” To add shadows, the user either selects the shadow icon 94 on the live view toolbar 58 or selects the VIEW button on the menu bar 84 and then selects the 3D SHADOWS button from the pop-out menu (not shown) that appears. Because the shadows will cast from the margins of the unmasked portions of the image 82, as previously indicated, it is important that only the object desired to be viewed remains unmasked in step 38 described above.

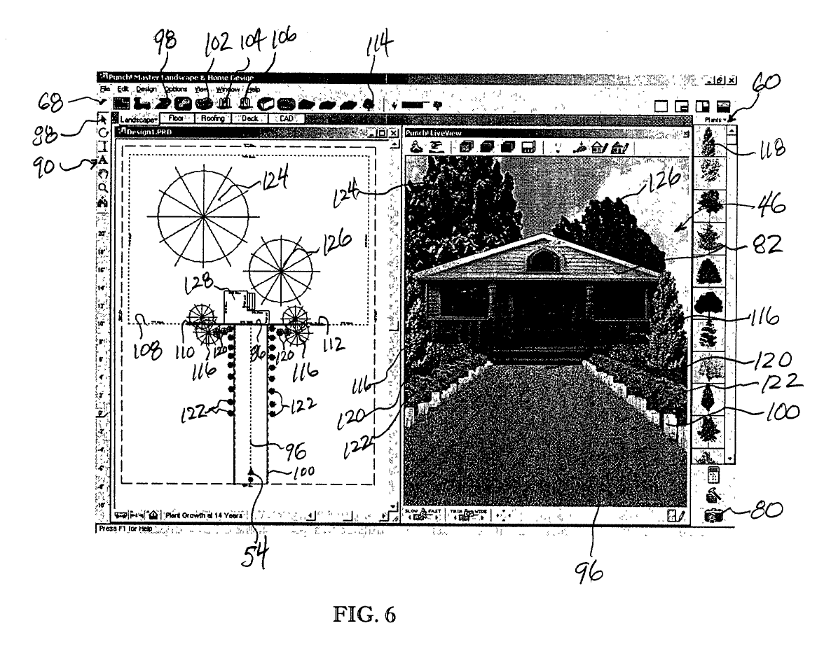

Once the two-dimensional digital image 82 has been placed in the three-dimensional environment 46, step 42 of editing the two-dimensional image and the three-dimensional environment enables the user to manipulate both the image 82 and the environment 46 to achieve the desired modifications. Particularly, step 42 is facilitated by the Additional Image Subprogram 32 to place additional digital images into the three-dimensional environment 46 for display with the two-dimensional digital image 82 on the display 18. As illustrated in FIG. 6, the user can select both two-dimensional and three-dimensional images from a variety of databases for placement into the environment 46. For example, as illustrated in FIG. 6, a pathway 96 has been added in front of the image 82 by selecting the pathway icon 98 from the landscape toolbar 68. Once the pathway icon 98 has been selected various pathway widths (not shown) appear on the preview bar 60. After selecting the desired pathway width, the user draws the location on the plan view by clicking the mouse 22 on the starting and ending points. The user can modify the texture of the pathway 96 by using the texture icon 56 as previously described. In a similar manner, edging 100 can be added by selecting the edging icon 102 on the landscape toolbar 68 and drawing the edging in the plan view. Similarly, by selecting the respective fencing icon 104 and/or gate icon 106 from the landscape toolbar 68, selecting the desired fencing and/or gate type from the databases displayed on the preview bar 60, and drawing the desired fence and/or locating the desired gate in the plan view, a fence 108 and/or gates 110 and 112 can be added to the environment 46.

A wide variety of plants selected from a multitude of various databases can be added to the environment 46. To add plants, the user selects the plant icon 114 from the landscape toolbar 68 and then selects the PLANTS button above the preview bar 60 causing a plant pop-out menu (not shown) to appear listing various plant databases. The user then simply selects the desired database button causing the selection of plants in that database to appear on the preview bar 60 and clicks and drags the desired specific plant to the desired location on the plan view. For example, Douglas Firs 116 can be added by selecting the TREE button from the plant pop-out menu and clicking and dragging the Douglas Fir icon 118 from the preview bar 60 to the desired location in the plan view. In a similar manner, various plants can be added, including for example flowers 120, shrubs 122, etc.. To customize a plant that has been added, the user can simply use the selection tool icon 88 and right-click on the plant the user wishes to modify causing a pop-out menu to appear with varying modification selections. For example, the Firs 116, the flowers 120, and the shrubs 122 are all shown as seedlings. However the Giant Pecan 124 and the Sugar Maple 126 are shown as planted at four years and two years, respectively. The user accomplishes these planting age modifications by selecting the PLANTING AGE button from the pop-out menu causing a Planting Age dialog box (not shown) to appear in which the user can enter the desire planting age using the keyboard 20. When the user selects the OK button on the Planting Age dialog box, the selected plant is enlarged to the corresponding planting age.

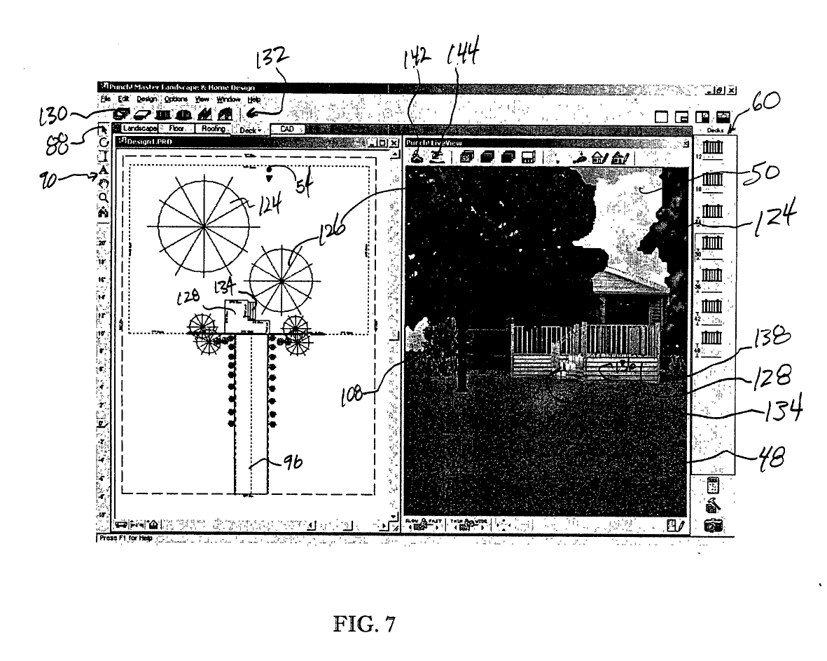

The edging 100, the fence 108, and the gates 110 and 112 are examples of three-dimensional images that the user can add to the environment 46. All of the various plants described above are two-dimensional images that the user can add. The plants, however, appear in the environment 46 to be three-dimensional objects. As detailed below, the Subprogram 34 accomplishes this be maintaining the planar plant images perpendicular to the viewpoint. Additionally, the Subprogram 32 enables the user to generate three-dimensional images by combining standard components. For example, the deck 128 is a three-dimensional image that the user can construct be selecting various components from a variety of databases (see FIGS. 6-8). The deck 128, as illustrated in FIG. 7, was added by selecting the deck icon 130 from the deck toolbar 132. The user then selects the height of the deck 128 from the ground from the preview bar 60, and then draws the deck on the plan view. Various components of the deck 128 can then be added and modified in a similar manner using the deck toolbar 132 and/or corresponding pop-out menus. For example, the user can add steps 134 by using the selection icon 88 and right-clicking on the deck 128 at the desired position to add the steps 134. A pop-out menu appears from which the user can select the INSERT STEPS button and the steps 134 are added at the selected location.

As previously indicated, the three-dimensional appearance of the images within the environment 46 is enhanced by the addition of shadows cast from the images. The user adds these shadows by simply selecting the shadow icon 88 on the live view toolbar 58. Corresponding to the selected light settings, shadows are cast from both the two-dimensional images and the three dimensional images. For example, a shadow 136 is cast from the two-dimensional Sugar Maple 126 as shown in FIG. 7. Shadows 138 and 140 are cast from the three-dimensional deck 128 and fence 108, respectively, as shown in FIGS. 7 and 8.

Various alternative editing features can be utilized to enhance the three-dimensional “affect” or appearance of the image 82. For example, additional two-dimensional digital images can be overplaned, or placed in front of, the image 82, such as images of modified windows, doors, etc.. It is important, however, that such images be cropped and/or masked and scaled so that the actual desired image covers the previous window, door, etc.. Additionally, because the image 82 is projected onto a plane, from a side view, the image 82 appears as a plane (see FIG. 8). To overcome this, the user could take four photographs, one of each side of the structure to be viewed, and place the images into the environment 46 in the manner described above so that the four images cooperate to form a four sided box, rather than simply a plane.

Step 44 of virtually viewing the three-dimensional environment and images therein from various perspectives enables the user to provide a virtual viewpoint within the three-dimensional environment 46 so that the user viewing the display 18 visualizes the environment 46 as if the user is positioned therein at the viewpoint and permits the user to selectively change the viewpoint. The Virtual Viewpoint Subprogram 34 preferably facilitates the step 44 to enable the user to “walk through” the environment 46. As shown in FIGS. 6-8, as the user simply selects the walk through icon 142 or the fly over icon 144 on the live view toolbar 58 and then uses the mouse 22 to maneuver through the environment 46. As the user changes the viewpoint, as marked by the viewpoint carat 54, the Subprogram 34 displays the three-dimensional images placed by the Subprogram 32 in perspective so that the perspective dimensions change as the viewpoint varies. With the exception of the image 82, the two-dimensional images placed by the Subprogram 32 are planar images and the Subprogram 34 maintains the planar images perpendicular to the viewpoint as the viewpoint changes to “affect” a three-dimension appearance. This “affect” is optimized when used with generally symmetrical objects, such as plants. As previously described, the shading and shadowing further enhance the three-dimensional “affect” even with regard to the image 82.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventor hereby states his intent to rely on the Doctrine of Equivalents to determine and assess the reasonably fair scope of the present invention as pertains to any apparatus not materially departing from but outside the literal scope of the invention as set forth in the following claims.

What is claimed is:

1. A method of viewing a two-dimensional digital image within a three-dimensional environment, the method comprising the steps of:
(a) displaying the three-dimensional environment on a computer display;
(b) preparing the two-dimensional digital image for placement into the three-dimensional environment;
(c) placing the two-dimensional digital image into the three-dimensional environment for display on the computer display;
(d) selectively placing additional digital images into the three-dimensional environment for display with the two-dimensional digital image on the computer display;
(e) providing a virtual viewpoint within the three-dimensional environment so that a user viewing the display visualizes the three-dimensional environment as if the user is positioned therein at the virtual viewpoint; and
(f) permitting the user to selectively change the viewpoint to enable the user to visualize the images in the three-dimensional environment from various viewpoints.

2. The method as claimed in claim 1,
step (a) including the steps of defining a fixed horizon through the three-dimensional environment and selecting a location for placement of a light source above the horizon to represent the sun.

3. The method as claimed in claim 2,
step (a) further including the steps of defining a border below the horizon for the three-dimensional environment using preselected dimensions and defining a topography within the border for the three-dimensional environment using preselected slopes.

4. The method as claimed in claim 2,
step (a) further including the step of shading the three-dimensional environment so that the shading is lighter towards the light source location and darker further away from the light source location.

5. The method as claimed in claim 2,
step (a) further including the step of shadowing the three-dimensional environment so that the two-dimensional digital image is located between the light source location and the shadowing.

6. The method as claimed in claim 1,
step (b) further including the steps of downloading a two-dimensional image into a computer memory and formatting it into the digital image for display on the computer display.

7. The method as claimed in claim 6,
wherein the two-dimensional image is a photograph created with a non-digital camera and the step of downloading the image includes scanning the photograph into the computer memory.

8. The method as claimed in claim 6,
wherein the two-dimensional image is a photograph created with a digital camera.

9. The method as claimed in claim 6,
step (b) further including the steps of cropping and masking at least a portion of the two-dimensional digital image and defining dimensions for the digital image relative to the three-dimensional environment.

10. The method as claimed in claim 1,
step (c) further including the step of projecting the two-dimensional digital image onto a transparent plane.

11. The method as claimed in claim 9,
step (c) further including the steps of projecting the two-dimensional digital image onto a transparent plane and rendering the at least a portion of the digital image that is masked transparent so that only the unmasked portion of the digital image is displayed on the computer display.

12. The method as claimed in claim 11,
step (a) further including the steps of defining a fixed horizon through the three-dimensional environment, selecting a location for placement of a light source above the horizon to represent the sun, shading the three-dimensional environment so that the shading is lighter towards the light source location and darker further away from the light source location, and shadowing the three-dimensional environment so that the two-dimensional digital image is located between the light source location and the shadowing,
step (c) further including the steps of shading and shadowing the unmasked portion of the two-dimensional digital image so that it generally matches the shading and the shadowing of the three-dimensional environment.

13. The method as claimed in claim 1,
step (c) further including the step of placing the two-dimensional digital image in the three-dimensional environment so that the digital image can be viewed on the display in both elevation and plan views.

14. The method as claimed in claim 1,
wherein the additional digital images of step (d) includes a second two-dimensional digital image defined in a plane and wherein the plane remains perpendicular to the virtual viewpoint as the user selectively changes the viewpoint.

15. The method as claimed in claim 1,
wherein the additional digital images of step (d) includes a three-dimensional digital image.

16. The method as claimed in claim 15,
said three-dimensional digital image being generated by the user by combining a plurality of three-dimensional digital image components selected from a pre-filled database.

17. The method as claimed in claim 15,
step (e) further including the steps of dimensioning the three-dimensional digital image so that it is viewed in perspective from the virtual viewpoint and changing the dimensions as the user selectively changes the viewpoint to maintain the perspective view.

18. A computer program for viewing a two-dimensional digital image within a three-dimensional environment, the computer program being stored on a computer-readable medium and executable by a computing device, the computer program comprising:
a first code segment for displaying the three-dimensional environment on a computer display;
a second code segment for preparing the two-dimensional digital image for placement into the three-dimensional environment;
a third code segment for placing the two-dimensional digital image into the three-dimensional environment for display on the computer display;
a fourth code segment for selectively placing additional digital images into the three-dimensional environment for display with the two-dimensional digital image on the computer display;
a fifth code segment for providing a virtual viewpoint within the three-dimensional environment so that a user viewing the display visualizes the three-dimensional environment as if the user is positioned therein at the virtual viewpoint; and
a sixth code segment for permitting the user to selectively change the viewpoint to enable the user to visualize the images in the three-dimensional environment from various viewpoints.

19. The computer program as claimed in claim 18,
said first code segment be operable to define a fixed horizon through the three-dimensional environment and select a location for placement of a light source above the horizon to represent the sun.

20. The computer program as claimed in claim 19,
said first code segment being further operable to define a border below the horizon for the three-dimensional environment using preselected dimensions and defining a topography within the border for the three-dimensional environment using preselected slopes.

21. The computer program as claimed in claim 19,
said first code segment being further operable to shade the three-dimensional environment so that the shading is lighter towards the light source location and darker further away from the light source location.

22. The computer program as claimed in claim 19,
said first code segment being further operable to shadow the three-dimensional environment so that the two-dimensional digital image is located between the light source location and the shadowing.

23. The computer program as claimed in claim 18,
said second code segment being operable to download a two-dimensional image into a computer memory and formatting it into the digital image for display on the computer display.

24. The computer program as claimed in claim 23,
wherein the two-dimensional image is a photograph created with a non-digital camera and the second code segment is further operable to scan the photograph into the computer memory.

25. The computer program as claimed in claim 23,
wherein the two-dimensional image is a photograph created with a digital camera.

26. The computer program as claimed in claim 23,
said second code segment being further operable to crop and mask at least a portion of the two-dimensional digital image and define dimensions for the digital image relative to the three-dimensional environment.

27. The computer program as claimed in claim 18,
said third code segment being operable to project the two-dimensional digital image onto a transparent plane.

28. The computer program as claimed in claim 26,
said third code segment being operable to project the two-dimensional digital image onto a transparent plane and render the at least a portion of the digital image that is masked transparent so that only the unmasked portion of the digital image is displayed on the computer display.

29. The computer program as claimed in claim 28,
said first code segment being operable to define a fixed horizon through the three-dimensional environment, select a location for placement of a light source above the horizon to represent the sun, shade the three-dimensional environment so that the shading is lighter towards the light source location and darker further away from the light source location, and shadow the three-dimensional environment so that the two-dimensional digital image is located between the light source location and the shadowing,
said third code segment being further operable to shade and shadow the unmasked portion of the two-dimensional digital image so that it generally matches the shading and the shadowing of the three-dimensional environment.

30. The computer program as claimed in claim 18,
said third code segment being operable to place the two-dimensional digital image in the three-dimensional environment so that the digital image can be viewed on the display in both elevation and plan views.

31. The computer program as claimed in claim 18,
wherein the additional digital images placed by the fourth code segment includes a second two-dimensional digital image defined in a plane and wherein the plane remains perpendicular to the virtual viewpoint as the user selectively changes the viewpoint.

32. The computer program as claimed in claim 18,
wherein the additional digital images placed by the fourth code segment includes a three-dimensional digital image.

33. The computer program as claimed in claim 32,
said three-dimensional digital image being generated by the user by combining a plurality of three-dimensional digital image components selected from a pre-filled database.

34. The computer program as claimed in claim 32,
said fifth code segment being operable to dimension the three-dimensional digital image so that it is viewed in perspective from the virtual viewpoint and changing the dimensions as the user selectively changes the viewpoint to maintain the perspective view.

35. Data created by a computer program for viewing a two-dimensional digital image within a three-dimensional environment, the computer program being stored on a computer-readable medium and executable by a computing device, the computer program comprising:
a code segment for displaying the three-dimensional environment on a computer display;
a code segment for preparing the two-dimensional digital image for placement into the three-dimensional environment;
a code segment for placing the two-dimensional digital image into the three-dimensional environment for display on the computer display;
a code segment for selectively placing additional digital images into the three-dimensional environment for display with the two-dimensional digital image on the computer display;
a code segment for providing a virtual viewpoint within the three-dimensional environment so that a user viewing the display visualizes the three-dimensional environment as if the user is positioned therein at the virtual viewpoint; and
a code segment for permitting the user to selectively change the viewpoint to enable the user to visualize the images in the three-dimensional environment from various viewpoints.
